(19) United States
(12) Patent Application Publication
(10) Pub. No.: US 2017/0169967 A1
(43) Pub. Date: Jun. 15, 2017

(54) OPTICAL SWITCH KEYBOARD

(71) Applicant: PRIMAX ELECTRONICS LTD., Taipei City (TW)

(72) Inventors: Bo-An Chen, Taipei City (TW); Chien-Hung Liu, Taipei City (TW)

(21) Appl. No.: 15/189,819

(22) Filed: Jun. 22, 2016

Related U.S. Application Data
(60) Provisional application No. 62/267,067, filed on Dec. 14, 2015.

(30) Foreign Application Priority Data
Apr. 22, 2016 (TW) 105112631

(51) Int. Cl. H01H 13/83; H01H 13/06

(52) U.S. Cl. CPC H01H 13/83; H01H 13/06; H01H 2219/054

(57) ABSTRACT

An optical switch keyboard includes a circuit module and plural keys. The plural keys are disposed over the circuit module. The circuit module includes a circuit board, plural light emitters and plural light receivers. Each key is disposed on a top surface of the circuit board. Each key corresponds to a light emitter and a light receiver. The plural light emitters and the plural light receivers are disposed on a bottom surface of the circuit board. Consequently, the plural light emitters and the plural light receivers are not interfered by the ambient light that comes from the top side of the circuit board. In addition, the optical switch keyboard has waterproof structures to prevent foreign liquid from entering the optical switch keyboard.

### FIELD OF THE INVENTION

The present invention relates to a keyboard, and more particularly to a keyboard with optical switches.

### BACKGROUND OF THE INVENTION

A keyboard is an essential input device of a computer system. The keyboard is equipped with many keys. By depressing a key of the keyboard, a command is inputted into the computer system. Conventionally, many kinds of keys are designed to generate key signals. For example, a mechanical key uses a conductive pin to trigger a circuit switch to generate a key signal. In addition, an optical key generates a key signal according to the result of receiving or obstructing a sensing light.

FIG. 1 is a schematic view illustrating the structure of a conventional optical switch 9. As shown in FIG. 1, a key part 84 is disposed over a circuit board 83 for being pressed by a user. A light emitter 81 and a light receiver 82 for generating a conducting signal are opposed to each other. Moreover, the light emitter 81 and the light receiver 82 are arranged between the key part 84 and the circuit board 83. While the key part 84 is depressed, a shield arm 84a of the key part 84 is inserted into the space between the light emitter 81 and the light receiver 82 to obstruct the optical path between the light emitter 81 and the light receiver 82. Meanwhile, the sensing light from the light emitter 81 cannot be received by the light receiver 82, and thus the optical switch 9 generates a triggering signal.

However, the conventional optical switch 9 still has some drawbacks. As shown in FIG. 1, the light emitter 81, the light receiver 82 and the key part 84 are arranged at the same side of the circuit board 83. That is, all of the key part 84, the light emitter 81 and the light receiver 82 are disposed over the circuit board 83. Moreover, there is a gap between every two adjacent key parts 84. Generally, dust or liquid easily flies or permeates into the gap between the adjacent key parts 84 and stays on the circuit board 83. Because of the interference of dust or liquid, the sensing light from the light emitter 81 cannot be precisely received by the light receiver 82. Under this circumstance, a misjudgment problem occurs, and the precision of the optical switch is deteriorated. Therefore, the conventional optical switch needs to be further improved.

### SUMMARY OF THE INVENTION

The present invention provides an optical switch keyboard. A key is disposed over the circuit board. A light emitter and a light receiver for generating a conducting signal are disposed under the circuit board. By this design, the light receiver is not interfered by foreign matters or ambient light. Consequently, the judging sensitivity and accuracy of the optical key are both increased.

In accordance with an aspect of the present invention, there is provided an optical switch keyboard. The optical switch keyboard includes a circuit module and plural keys. The circuit module includes a circuit board, plural light emitters and plural light receivers corresponding to the plural light emitters. The plural light emitters are disposed on a bottom surface of the circuit board. Each of the plural light emitters emits a sensing light. The plural light receivers are disposed on the bottom surface of the circuit board. When the light receiver receives the sensing light from the corresponding light emitter, the light receiver generates a corresponding conducting signal. The plural keys correspond to the plural light emitters, the plural light receivers and the plural light sources, respectively. The plural keys are disposed on a top surface of the circuit board. Each of the plural keys includes a keycap, a housing assembly and a triggering element. The housing assembly is disposed under the keycap. The triggering element is connected with the keycap and penetrated through the housing assembly. When the triggering element is in a first position, the sensing light from the light emitter is received by the light receiver. When the triggering element is in a second position, the sensing light from the light emitter is not received by the light receiver. Moreover, the circuit board generates a corresponding triggering signal according to a status change of the conducting signal.

In an embodiment, the circuit module further includes plural light sources, and the plural light sources are disposed on the top surface of the circuit board and electrically connected with the circuit board. Each light source is aligned with the corresponding key. A light beam from the light source is directed to the corresponding keycap.

In an embodiment, the optical switch keyboard further includes a keyboard base under the circuit module, and the keyboard base includes plural light-shading walls. The plural light-shading walls are protruded upwardly from the keyboard base toward the circuit module. An accommodation space is defined by the corresponding light-shading wall to accommodate the corresponding light emitter and the corresponding light receiver. The light emitter and the light receiver are shaded from ambient light by the corresponding light-shading wall.

In an embodiment, the circuit board includes plural perforations under the corresponding keys. The triggering element has a light obstructing part. When the triggering element is moved downwardly, the light obstructing part is protruded through the corresponding perforation to be in an optical path of the sensing light from the light emitter.

In an embodiment, when the triggering element is in the first position, the sensing light from the light emitter is received by the light receiver. When the triggering element is in the second position, the light obstructing part is protruded through the corresponding perforation to be in the optical path of the sensing light from the light emitter, so that the sensing light from the light emitter is obstructed by the light obstructing part and not received by the light receiver.

In an embodiment, the optical switch keyboard further includes plural waterproof plates. Each waterproof plate is arranged between the corresponding housing assembly and the corresponding keycap and disposed on a top surface of the corresponding housing assembly. An upper opening is formed in the top surface of the housing assembly. The waterproof plate has a waterproof plate opening corresponding to the upper opening. The triggering element is penetrated through the upper opening of the housing assembly and the waterproof plate opening and connected with the keycap.

In an embodiment, the optical switch keyboard further includes plural waterproof rings. Each waterproof ring is arranged between the corresponding housing assembly and the circuit board. The waterproof ring is disposed on a bottom surface of the corresponding housing assembly. A lower opening is formed in a bottom surface of the housing assembly. Each waterproof ring has a waterproof ring opening corresponding to the lower opening of the bottom surface of the housing assembly and the corresponding perforation of the circuit board. Each waterproof ring is clamped between the corresponding housing assembly and the circuit board, so that a space between the housing assembly and the circuit board is enclosed and sealed by the waterproof ring. The triggering element is penetrated through the lower opening of corresponding housing assembly, the corresponding waterproof ring opening and the corresponding perforation of the circuit board.

In an embodiment, each key includes a positioning post, and the circuit board has plural first positioning holes. Each key is disposed over the corresponding first positioning hole. The positioning post of the key is inserted into the corresponding first positioning hole of the circuit board, so that the key is fixed on the circuit board.

In an embodiment, the optical switch keyboard further includes a positioning plate. The positioning plate has plural second positioning holes. Each key is penetrated through the corresponding second positioning hole of the positioning plate.

In an embodiment, each key further includes an elastic element. A first end of the elastic element is contacted with the triggering element. A second end of the elastic element is contacted with the housing assembly. When the keycap is depressed, the triggering element is moved downwardly to the second position. When the keycap is released, the triggering element is returned to the first position in response to an elastic force of the elastic element.

In an embodiment, each key further includes a spring strip. The spring strip is accommodated within the housing assembly. When the keycap is depressed and the triggering element is moved downwardly, the spring strip is activated to generate a feedback sound.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating the structure of two conventional optical switches;

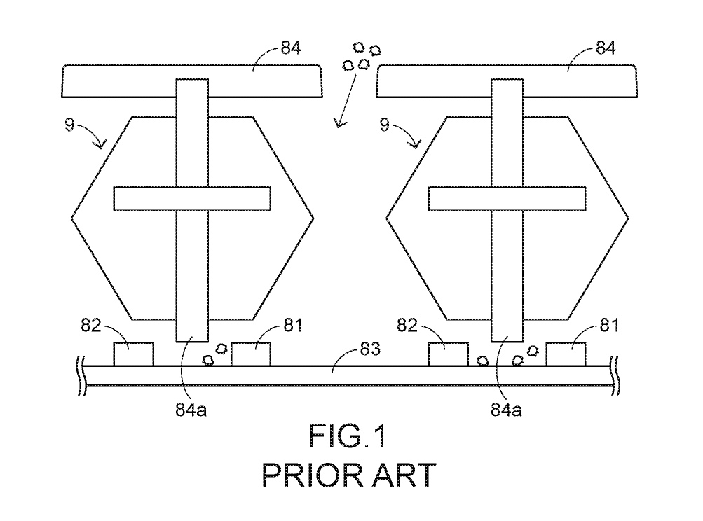

FIG. 2 is a schematic top view illustrating an optical switch keyboard according to an embodiment of the present invention;

FIG. 3 is a schematic perspective view illustrating a single optical switch of the optical switch keyboard according to a first embodiment of the present invention;

FIG. 4 is a schematic exploded view illustrating the optical switch of the optical switch keyboard according to the first embodiment of the present invention;

FIG. 5 is a schematic cross-sectional view illustrating the optical switch according to the first embodiment of the present invention, in which the key is not depressed and the triggering element is in a non-depressed position;

FIG. 6 is a schematic cross-sectional view illustrating the optical switch according to the first embodiment of the present invention, in which the key is depressed and the triggering element is in a depressed position;

FIG. 7 is a schematic cross-sectional view illustrating an optical switch according to a second embodiment of the present invention, in which the key is not depressed and the triggering element is in a non-depressed position; and

FIG. 8 is a schematic cross-sectional view illustrating an optical switch according to the second embodiment of the present invention, in which the key is depressed and the triggering element is in a depressed position.

### DETAILED DESCRIPTION OF THE PREFERRED EMBODIMENT

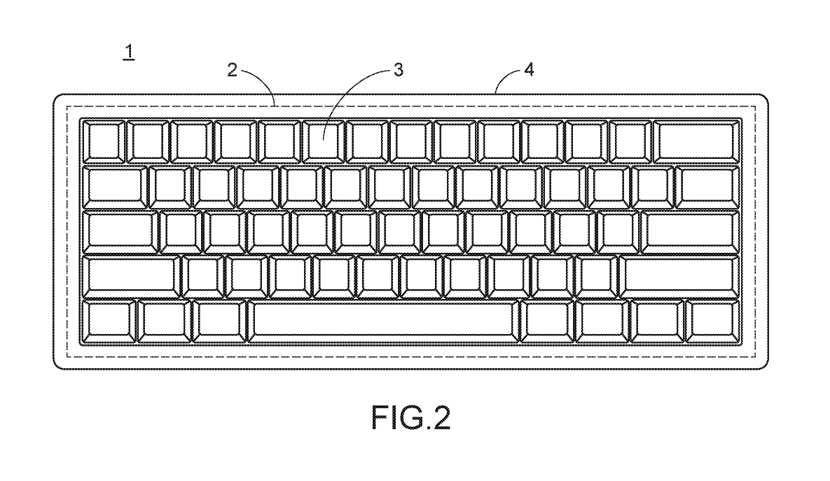

FIG. 2 is a schematic top view illustrating an optical switch keyboard according to an embodiment of the present invention. As shown in FIG. 2, the optical switch keyboard 1 comprises a circuit module 2, plural keys 3 and an outer shell 4. The plural keys 3 are disposed on the circuit module 2. Moreover, plural optical switches are defined by the plural keys 3 and the circuit module 2 collaboratively. The periphery of the circuit module 2 is covered by the outer shell 4, and the plural keys 3 are enclosed by the outer shell 4. Consequently, the outer appearance of the optical switch keyboard is constructed.

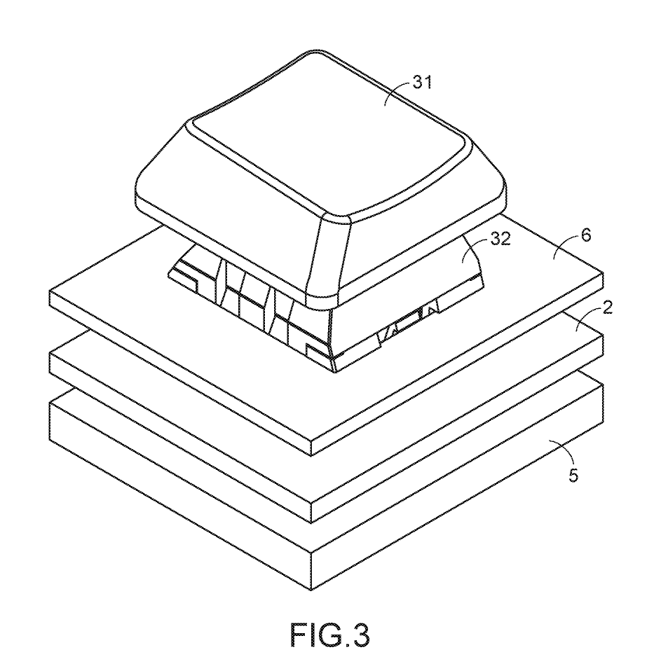

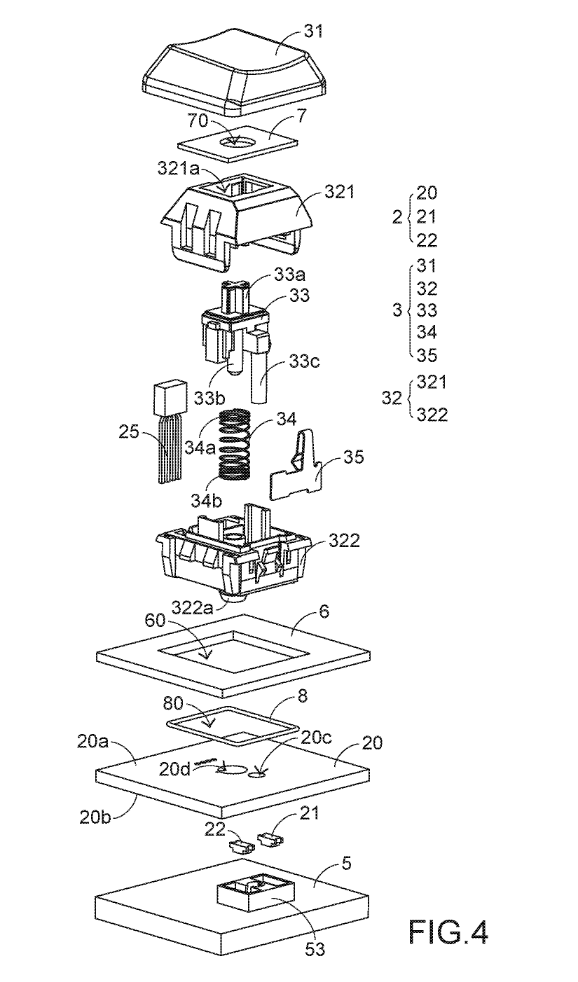

For succinctness, only a single optical switch is shown in FIGS. 3 and 4. FIG. 3 is a schematic perspective view illustrating a single optical switch of the optical switch keyboard according to a first embodiment of the present invention. FIG. 4 is a schematic exploded view illustrating the optical switch of the optical switch keyboard according to the first embodiment of the present invention. As shown in FIGS. 3 and 4, the key 3 comprises a keycap 31, a housing assembly 32, a triggering element 33, an elastic element 34 and a spring strip 35. The keycap 31 is located at the outermost position of the key 3. In a normal placement of the keyboard, the keycap 31 is at the topmost side to be depressed by the user. The housing assembly 32 is disposed under the keycap 31. Moreover, the housing assembly 32 is arranged between the keycap 31 and the circuit module 2. The housing assembly 32 comprises an upper housing 321 and a lower housing 322. Since the upper housing 321 and the lower housing 322 are detachably coupled with each other, the triggering element 33, the elastic element 34 and the spring strip 35 can be accommodated within the space between the upper housing 321 and the lower housing 322 during the process of assembling the key 3.

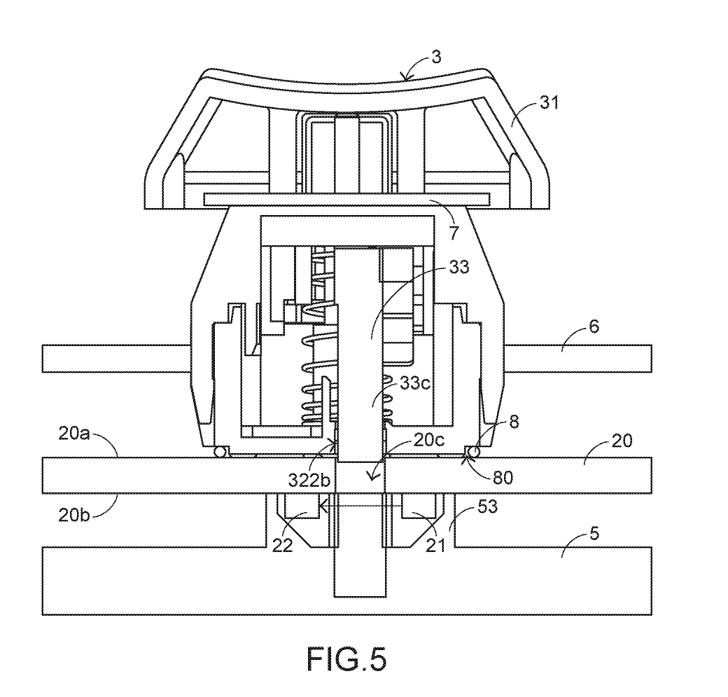

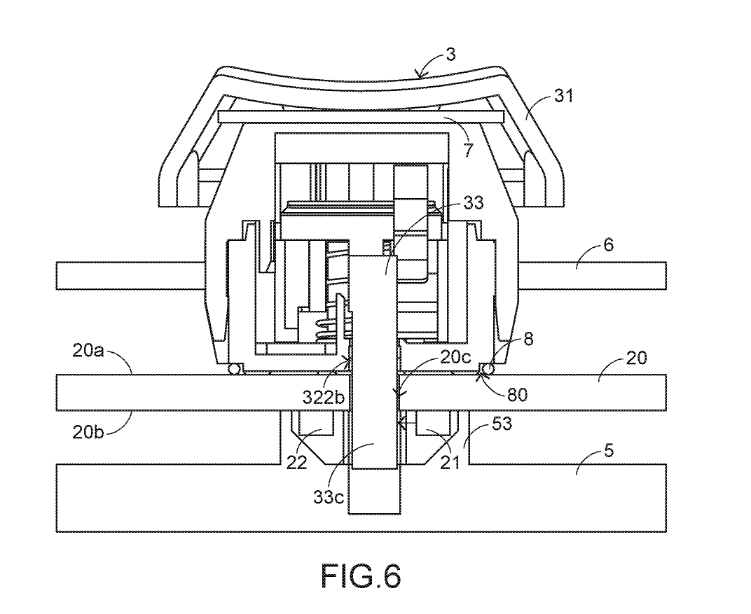

Moreover, the triggering element 33 is accommodated within the housing assembly 32. The triggering element 33 has a first end 33a and a second end 33b, which are opposed to each other. The first end 33a of the triggering element 33 is protruded out of the upper housing 321 through an upper opening 321a of the upper housing 321 and fixed on a bottom surface of the keycap 31. The second end 33b of the triggering element 33 is contacted with the elastic element 34. A first end 34a of the elastic element 34 is contacted with the triggering element 33. A second end 34b of the elastic element 34 is contacted with the lower housing 322. While the keycap 31 is moved downwardly in response to the depressing force of the user, the triggering element 33 is moved toward the circuit module 2 in response to the force. Since the elastic element 34 is compressed by the triggering element 33, elastic potential energy is stored in the elastic element 34. Before the keycap 31 is depressed, the keycap 31 and the triggering element 33 are in a non-depressed position (see FIG. 5). After the keycap 31 is depressed, the keycap 31 and the triggering element 33 are moved downwardly to a depressed position (see FIG. 6) in response to the force. When the key 3 is released by the user, the elastic potential energy in the elastic element 34 is gradually released and thus the keycap 31 and the triggering element 33 are returned to the non-depressed position. The action of depressing the key 3 and the action of returning the key 3 are described as above.

The structure of the circuit module 2 will be illustrated in more details as follows. Please refer to FIG. 4 again. The circuit module 2 comprises the circuit board 20, plural light emitters 21, plural light receivers 22 and plural light sources 25. The keys 3 are disposed over the circuit board 20. The light emitters 21 and the light receivers 22 are disposed under the circuit board 20. Preferably, the keys 3 are disposed on a top surface 20a of the circuit board 20, and the light emitters 21 and the light receivers 22 are disposed on a bottom surface 20b of the circuit board 20. The light emitters 21 and the light receivers 22 are in communication with the circuit board 20. Moreover, the light emitter 21 emits a sensing light. When the sensing light is received by the corresponding light receiver 22, a conducting signal is generated.

For allowing the light receiver 22 to selectively receiving the sensing light from the corresponding light emitter 21 according to the action of depressing the keycap, the circuit board 20 is with plural perforations 20c. While a keycap 31 is depressed, the corresponding triggering element 33 is protruded downwardly through the corresponding perforation 20c to the position under the circuit board 20 so as to obstruct the sensing light of the light emitter 21. Moreover, while the keycap 31 is depressed by the user and the triggering element 33 is correspondingly moved downwardly, the spring strip 35 is activated to generate a feedback sound. Due to the feedback sound, the acoustic effect of depressing the keycap is enhanced.

The operations of the light emitter 21 and the light receiver 22 will be illustrated with reference to FIGS. 5 and 6. FIG. 5 is a schematic cross-sectional view illustrating the optical switch according to the first embodiment of the present invention, in which the key is not depressed and the triggering element is in a non-depressed position. FIG. 6 is a schematic cross-sectional view illustrating the optical switch according to the first embodiment of the present invention, in which the key is depressed and the triggering element is in a depressed position. In this embodiment, the light emitter 21 and the light receiver 22 face each other. The way of generating the conducting signal will be illustrated as follows. The triggering element 33 comprises a light obstructing part 33c for obstructing the sensing light. Since the key 3 is disposed over the corresponding perforation 20c, the light obstructing part 33c is aligned with the corresponding perforation 20c. Consequently, while the keycap 31 is depressed and the triggering element 33 is moved downwardly, the light obstructing part 33c is protruded downwardly through the corresponding perforation 20c to the position under the circuit board 20. As shown in FIG. 5, the keycap 31 is not depressed and the triggering element 33 is in the non-depressed position. Since the triggering element 33 is not moved downwardly to the same level as the light emitter 21 and the light receiver 22, the sensing light from the light emitter 21 can be received the light receiver 22 and the conducting signal is generated. As shown in FIG. 6, the keycap 31 is depressed and the triggering element 33 is in the depressed position. Meanwhile, the light obstructing part 33c is protruded downwardly through the corresponding perforation 20c to the same level as the light emitter 21 and the light receiver 22. That is, the light obstructing part 33c is protruded to a position in the optical path of the sensing light from the light emitter 21. Since the sensing light from the light emitter 21 is obstructed by the light obstructing part 33c, the sensing light cannot be received by the light receiver 22. Consequently, the conducting signal is interrupted. According to a change of the conducting signal from a generated status to an interrupted status, the circuit board 20 generates a corresponding triggering signal.

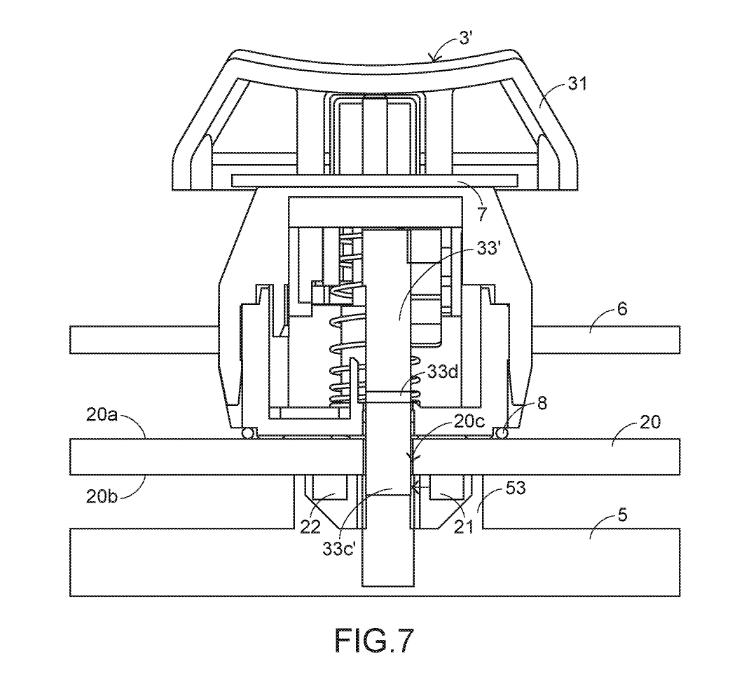

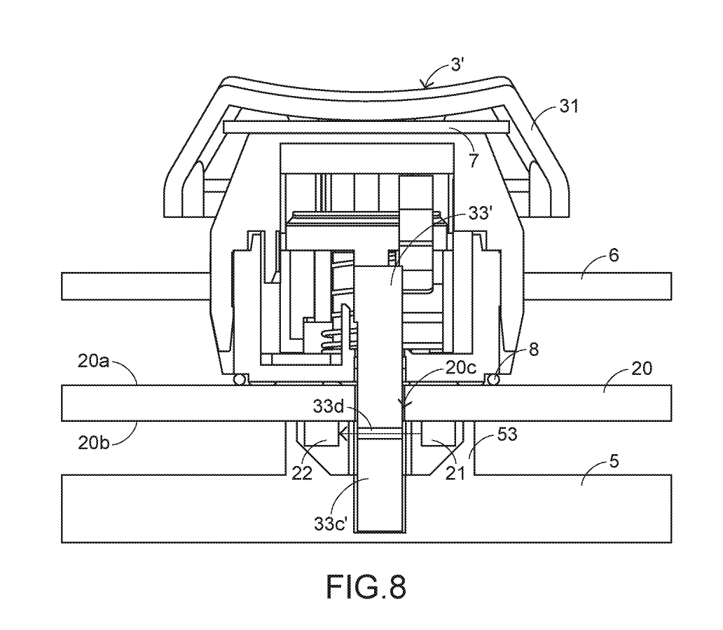

It is noted that the positions of the light emitter 21 and the light receiver 22 are not restricted. FIG. 7 is a schematic cross-sectional view illustrating an optical switch according to a second embodiment of the present invention, in which the key is not depressed and the triggering element is in a non-depressed position. FIG. 8 is a schematic cross-sectional view illustrating an optical switch according to the second embodiment of the present invention, in which the key is depressed and the triggering element is in a depressed position. Similarly, the light emitter 21 and the light receiver 22 face each other, and the light obstructing part 33c′ is used for obstructing the sensing light. In comparison with the first embodiment, the light obstructing part 33c′ of this embodiment has a light-transmissible aperture 33d. When the keycap 31 is not depressed and the triggering element 3 is in the non-depressed position, the light obstructing part 33c′ is protruded through the corresponding perforation 20c to a position in the optical path of the sensing light from the light emitter 21. Since the sensing light from the light emitter 21 is obstructed by the light obstructing part 33c′, the sensing light cannot be received by the light receiver 22. Consequently, no conducting signal is generated. After the keycap 3 is depressed and the triggering element 33 is moved downwardly to the depressed position, the light-transmissible aperture 33d of the light obstructing part 33c′ is correspondingly moved downwardly. Consequently, the light-transmissible aperture 33d is in the optical path of the sensing light from the light emitter 21. Since the sensing light from the light emitter 21 can be received by the light receiver 22, a conducting signal is generated. According to a change of the conducting signal from an interrupted status to a generated status, the circuit board 20 generates a corresponding triggering signal.

In the above embodiments of FIGS. 5-8, the light emitter 21 and the light receiver 22 face each other and the sensing light from the light emitter 21 is linearly irradiated on the light receiver 22. It is noted that numerous modifications and alterations may be made while retaining the teachings of the invention. For example, in another embodiment, the light emitter 21 and the light receiver 22 do not face each other. By a reflective surface or a refractive structure (not shown), the direction of the sensing light from the light emitter is changed and the sensing light is guided to the light receiver.

Please refer to FIGS. 3-8 again. The optical switch keyboard 1 further comprises a keyboard base 5. The keyboard base 5 is disposed under the circuit module 2. The keyboard base 5 further comprises plural light-shading walls 53. The plural light-shading walls 53 are protruded upwardly from the keyboard base 5 toward the circuit module 2. Consequently, an accommodation space is defined by the corresponding light-shading walls 53 collaboratively. A light emitter 21 and the corresponding light receiver 22 are accommodated within the accommodation space. Moreover, the light-shading wall 53 has a function of shading the light emitter 21 and the light receiver 22 from the ambient light.

The way of fixing the key 3 on the circuit board 20 will be described as follows. Please refer to FIG. 4. Each lower housing 322 has a positioning post 322a. The circuit board 20 has plural positioning holes 20d. Each key 3 is disposed over the corresponding positioning hole 20d. When the positioning post 322a of the lower housing 322 is inserted into the corresponding positioning hole 20d of the circuit board 20, the key 3 is fixed on the circuit board 20. In this embodiment, the optical switch keyboard 1 further comprises a positioning plate 6. The positioning plate 6 has plural second positioning holes 60. The size of the second positioning hole 60 matches the size of the housing assembly 32 of the key 3. When the housing assembly 32 is inserted into the corresponding second positioning hole 60, the housing assembly 32 is fixed and positioned in the second positioning hole 60.

The optical switch keyboard 1 further comprises plural waterproof structures at the seams of the housing assembly. The waterproof structures are used for preventing the foreign matters from entering the optical switch keyboard 1. For example, the optical switch keyboard 1 comprises plural waterproof plates 7. Each waterproof plate 7 is arranged between the corresponding housing assembly 32 and the corresponding keycap 31. The waterproof plate 7 is disposed on a top surface of the upper housing 321. The upper opening 321a is formed in the top surface of the upper housing 321. Moreover, the waterproof plate 7 has a waterproof plate opening 70 corresponding to the upper opening 321a of the upper housing 321. The first end 33a of the triggering element 33 is penetrated through the upper opening 321a of the upper housing 321 and the waterproof plate opening 70 of the waterproof plate 7, and connected with the keycap 31.

The optical switch keyboard 1 further comprises plural waterproof rings 8. Each waterproof ring 8 is arranged between the circuit board 20 and the corresponding housing assembly 32. As shown in FIGS. 5 and 6, a lower opening 322b is formed in a bottom surface of the lower housing 322. Each waterproof ring 8 has a waterproof ring opening 80. Each lower opening 322b of the housing assembly 32 is aligned with the corresponding waterproof ring opening 80 and the corresponding perforation 20c of the circuit board 20. Moreover, the triggering element 33 is penetrated through the lower opening 322b of the lower housing 322, the waterproof ring opening 80 of the waterproof ring 8 and the perforation 20c of the circuit board 20. The waterproof ring 8 is disposed on a bottom surface of the corresponding housing assembly 32, and clamped between the corresponding housing assembly 32 and the circuit board 20. Consequently, the space between the housing assembly 32 and the circuit board 20 is enclosed and sealed by the waterproof ring 8. Under this circumstance, the waterproof efficacy is enhanced.

Please refer to FIG. 4 again. Each key 3 further comprises a light source 25. The light source 25 is disposed on the top surface 20a of the circuit board 20 through conductive pins. In the above embodiments, a part or the entire of the triggering element 33 is made of a light-transmissible material. That is, a part or the entire of the triggering element 33 is a light-transmissible zone. After the light beams emitted by the light source 25 are transmitted through the light-transmissible zone of the triggering element 33, the light beams are directed to the keycap 31. Consequently, the optical switch keyboard has the illuminating efficacy.

From the above descriptions, the present invention provides the optical switch keyboard. In the optical switch keyboard, the light emitter and the light receiver are disposed under the circuit board. By this design, the light emitter and the light receiver are not interfered by the dust, liquid or ambient light coming from the top side. Consequently, the precision of detecting signals will be largely increased. Moreover, the optical switch keyboard further comprises waterproof structures at the seams of the housing assembly. The waterproof structures can prevent liquid from entering the circuit board, and thus the detecting efficacy is enhanced.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. An optical switch keyboard, comprising:
a circuit module comprising:
a circuit board;
plural light emitters disposed on a bottom surface of the circuit board, wherein each of the plural light emitters emits a sensing light; and
plural light receivers corresponding to the plural light emitters, respectively, wherein the plural light receivers are disposed on the bottom surface of the circuit board, wherein when the light receiver receives the sensing light from the corresponding light emitter, the light receiver generates a corresponding conducting signal; and
plural keys disposed on a top surface of the circuit board, wherein each of the plural keys is corresponding to one of the plural light emitters and one of the plural light receivers, and each of the plural keys comprises:
a keycap;
a housing assembly disposed under the keycap; and
a triggering element connected with the keycap and penetrated through the housing assembly,
wherein the sensing light from the light emitter is received by the light receiver when the triggering element is in a first position, the sensing light from the light emitter is not received by the light receiver when the triggering element is in a second position, and the circuit board generates a corresponding triggering signal according to a status change of the conducting signal.

2. The optical switch keyboard according to claim 1, wherein the circuit module further comprises plural light sources, and the plural light sources are disposed on the top surface of the circuit board and electrically connected with the circuit board, wherein each light source is aligned with the corresponding key, and a light beam from the light source is directed to the corresponding keycap.

3. The optical switch keyboard according to claim 1, wherein the optical switch keyboard further comprises a keyboard base under the circuit module, and the keyboard base comprises plural light-shading walls, wherein the plural light-shading walls are protruded upwardly from the keyboard base toward the circuit module, an accommodation space is defined by the corresponding light-shading wall to accommodate the corresponding light emitter and the corresponding light receiver, and the light emitter and the light receiver are shaded from ambient light by the corresponding light-shading wall.

4. The optical switch keyboard according to claim 1, wherein the circuit board comprises plural perforations under the corresponding keys, and the triggering element has a light obstructing part, wherein when the triggering element is moved downwardly, the light obstructing part is protruded through the corresponding perforation to be in an optical path of the sensing light from the light emitter.

5. The optical switch keyboard according to claim 4, wherein when the triggering element is in the first position, the sensing light from the light emitter is received by the light receiver, wherein when the triggering element is in the second position, the light obstructing part is protruded through the corresponding perforation to be in the optical path of the sensing light from the light emitter, so that the sensing light from the light emitter is obstructed by the light obstructing part and not received by the light receiver.

6. The optical switch keyboard according to claim 4, wherein the optical switch keyboard further comprises plural waterproof plates, and each waterproof plate is arranged between the corresponding housing assembly and the corresponding keycap and disposed on a top surface of the corresponding housing assembly, wherein an upper opening is formed in the top surface of the housing assembly, the waterproof plate has a waterproof plate opening corresponding to the upper opening, and the triggering element is penetrated through the upper opening of the housing assembly and the waterproof plate opening to connect the keycap.

7. The optical switch keyboard according to claim 4, wherein the optical switch keyboard further comprises plural waterproof rings, each waterproof ring is arranged between the corresponding housing assembly and the circuit board, and the waterproof ring is disposed on a bottom surface of the corresponding housing assembly, wherein a lower opening is formed in a bottom surface of the housing assembly, and each waterproof ring has a waterproof ring opening corresponding to the lower opening of the bottom surface of the housing assembly and the corresponding perforation of the circuit board, wherein each waterproof ring is clamped between the corresponding housing assembly and the circuit board, so that a space between the housing assembly and the circuit board is enclosed and sealed by the waterproof ring, wherein the triggering element is penetrated through the lower opening of corresponding housing assembly, the corresponding waterproof ring opening and the corresponding perforation of the circuit board.

8. The optical switch keyboard according to claim 1, wherein each key comprises a positioning post, and the circuit board has plural first positioning holes, wherein each key is disposed over the corresponding first positioning hole, and the positioning post of the key is inserted into the corresponding first positioning hole of the circuit board, so that the key is fixed on the circuit board.

9. The optical switch keyboard according to claim 8, wherein the optical switch keyboard further comprises a positioning plate, and the positioning plate has plural second positioning holes, wherein each key is penetrated through the corresponding second positioning hole of the positioning plate.

10. The optical switch keyboard according to claim 1, wherein each key further comprises an elastic element, a first end of the elastic element is contacted with the triggering element, and a second end of the elastic element is contacted with the housing assembly, wherein when the keycap is depressed, the triggering element is moved downwardly to the second position, wherein when the keycap is released, the triggering element is returned to the first position in response to an elastic force of the elastic element.

11. The optical switch keyboard according to claim 1, wherein each key further comprises a spring strip, and the spring strip is accommodated within the housing assembly, wherein when the keycap is depressed and the triggering element is moved downwardly, the spring strip is activated to generate a feedback sound.
